(19) United States
(12) Patent Application Publication
(10) Pub. No.: US 2024/0294557 A1
(43) Pub. Date: Sep. 5, 2024

(54) ORGANOSILYL POLYSULFIDES, AND RUBBER MIXTURES CONTAINING SAME

(71) Applicant: LANXESS DEUTSCHLAND GMBH, COLOGNE (DE)

(72) Inventors: Hermann-Josef Weidenhaupt, Pulheim (DE); Irene Moll, Neuss (DE); Michaela Meiers, Aachen (DE)

(73) Assignee: LANXESS DEUTSCHLAND GMBH, COLOGNE (DE)

(21) Appl. No.: 18/570,149

(22) PCT Filed: Jun. 27, 2022
(86) PCT No.: PCT/EP2022/067478

§ 371 Date: Dec. 14, 2023

(30) Foreign Application Priority Data
Jun. 30, 2021 (EP) 21182837.1

(51) Int. Cl. C07F 7/18; B60C 1/00; C08J 3/24; C08K 3/04; C08K 3/36; C08K 5/00; C08K 5/548; C08L 9/06

(52) U.S. Cl. CPC C07F 7/1892; B60C 1/00; C08J 3/247; C08K 3/04; C08K 3/36; C08K 5/0025; C08K 5/548; C08L 9/06; C08J 2309/06; C08K 2201/005; C08K 2201/006

(57) ABSTRACT

The novel organosilyl polysulfides of formula (I)

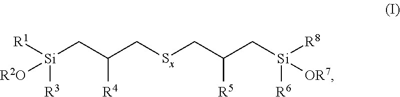

wherein the substituents R¹ to R⁸ and the index x have the definitions specified in the description,
are exceptionally suitable for the production of rubber mixtures having improved mixing properties, vulcanizates obtained therefrom and rubber products which feature higher hardness, strength and breaking elongation and a low rolling resistance of the tyres produced therefrom.

The present invention relates to novel organosilyl polysulfides and to the use thereof as reinforcing additives for rubber, to rubber mixtures containing these organosilyl polysulfides, and to the use of these organosilyl polysulfides for production of these rubber mixtures and to vulcanizates and moulded articles, in particular tyres, obtainable from these rubber mixtures.

Sulfur-containing organosilicon compounds which may be employed as reinforcing additives in rubber mixtures are known. Thus, DE-A 2141159, DE-A 2141160 and DE-A 2255577 describe sulfur-containing organosilanes as reinforcing additives especially for silica-containing rubber vulcanizates for tyre applications. The sulfur-containing organosilanes disclosed therein are derived from bis(trialkoxysilylalkyl)polysulfides, for example bis(triethoxysilylpropyl)tetrasulfide (TESPT) is explicitly described.

DE-A 2035778 also discloses organosilane-based reinforcing additives derived from trialkoxysilylpropyl compounds. The disadvantage of these compounds known from the prior art is that hysteresis losses are reduced not only at high temperatures (about 60° C., correlating with rolling resistance) but also at low temperatures (0° C.). A reduction in hysteresis losses is desirable in principle since it results in a reduction in the rolling resistance of motor vehicle tyres and thus in lower fuel consumption of vehicles. However it is known that a low hysteresis at low temperatures (0° C. to 20° C.) is associated with a poor wet skid resistance in motor vehicle tyres. It is therefore difficult to reconcile both requirements, namely low rolling resistance and good wet skid resistance.

EP-A 447066 also describes the use of sulfur-containing organosilanes as adhesion enhancers in rubber mixtures for production of highly silica-filled tyre treads. Therein, the combination of a special, silane-modified rubber, a silica filler and adhesion enhancers based on special trialkoxyalkyl polysulfides made it possible to reduce the rolling resistance of the tyre, but it is apparent in these tyre mixtures too that the abovementioned adhesion enhancers not only reduce rolling resistance but also reduce wet grip.

EP-A 0680997 likewise discloses the use of certain bis-alkoxy/alkyl-substituted silylmethylene polysulfides as reinforcing additives for rubber mixtures with good rolling resistance and good wet grip. Disadvantages here include that the raw materials used to produce the reinforcing additives require costly and inconvenient production via photochlorination and also that the rubbers exhibit considerable deterioration of performance characteristics such as strength, breaking elongation and hardness.

EP-A 3622015 describes the use of bis(dimethylethoxysilylisobutylene)polysulfide as a reinforcing additive for rubber mixtures having good rolling resistance and good wet grip properties. However, using these compounds in tyre production results in the release of 2 mol of ethanol per mol, and this may be disadvantageous in practice.

It is accordingly an object of the present invention to provide novel reinforcing additives for rubbers based on sulfur-containing organosilicon compounds as well as novel rubber mixtures which overcome the abovementioned disadvantages of the prior art.

It has surprisingly been found that certain organosilyl polysulfides that each have a propylene group or each have a propylene group branched in the 2-position as a spacer between the silicon and the sulfur atoms are very well suited as reinforcing additives for rubber mixtures, without vulcanization of the rubber mixture resulting in emission of volatile organic components (VOCs).

The novel organosilyl polysulfides bring about a fast complete vulcanization time (T95) of the rubber mixtures and in the vulcanizates obtainable therefrom result in advantageous temperature-dependent hysteresis properties and positive performance characteristics, such as high strength and high breaking elongation. Tyres produced from these vulcanizates especially feature a low rolling resistance and good wet grip. Furthermore, the novel organosilyl polysulfides feature very advantageous low mixing viscosities, thus allowing simpler mixture production.

The present invention accordingly provides novel organosilyl polysulfides of formula (I)

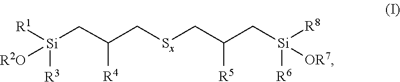

wherein
R¹, R³, R⁶ and R⁸ are identical or different and represent C₁-C₄-alkyl,
R⁴ and R⁵ are identical or different and represent hydrogen or C₁-C₄-alkyl,
R² and R⁷ represent a radical of formula (A)

H₂₇C₁₃—(OCH₂—CH₂)ₙ— (A),
wherein
n is an integer from 1 to 9, preferably from 2 to 8 and particularly preferably 5
and
x is an integer from 2 to 8.

Preference is given to organosilyl polysulfides of formula (I),
wherein
R¹, R³, R⁶ and R⁸ are identical or different and represent methyl or ethyl,
R⁴ and R⁵ are identical or different and represent hydrogen, methyl or ethyl,
R² and R⁷ represent a radical of formula (A),
wherein
n is an integer from 2 to 8, particularly preferably 5
and
x is an integer from 2 to 8.

Particular preference is given to organosilyl polysulfides of formula (I), wherein
R¹, R³, R⁶ and R⁸ represent methyl,
R⁴ and R⁵ are identical or different and represent hydrogen or methyl,
R² and R⁷ represent a radical of formula (A),
wherein
n is 3, 5, 6, 6.5, 7, 8, particularly preferably 5
and
x is an integer from 2 to 8.

Very particular preference is given to organosilyl polysulfides of formula (I), wherein
R¹, R³, R⁶ and R⁸ represent methyl,
R⁴ and R⁵ are identical and represent hydrogen or methyl,
R² and R⁷ represent a radical of formula (A),
wherein
n is 5
and
x is an integer from 2 to 8.

Especial preference is given to organosilyl polysulfides of formula (Ia) and (Ib)

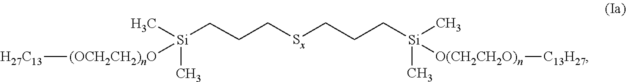

wherein
x is an integer from 2 to 8,
and
n is 5,
with the chemical name bis[penta(ethyleneoxy)tridecanoyldimethylsilylpropyl]polysulfide
and

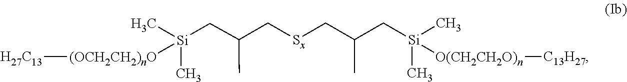

wherein
x is an integer from 2 to 8, and
n is 5,
with the chemical name bis[penta(ethyleneoxy)tridecanoyldimethylsilylisobutylpropyl]polysulfide.

It is known to those skilled in the art that organosilyl polysulfides can undergo disproportionation under the influence of temperature and/or solvents. The organosilyl polysulfides according to the invention are therefore mostly in the form of mixtures, wherein the number of sulfur atoms in the organosilyl polysulfides is in the range of a number-average which is generally 3.6 to 4.4, preferably 3.8 to 4.2 and in particular 4.0.

The present invention further provides mixtures containing at least two organosilyl polysulfides of formula (I), wherein the substituents R¹ to R⁸ and x have the abovementioned general and preferred definitions and which differ at least in the value of x, wherein the number-average x̅ of the number x of sulfur atoms is 3.6 to 4.4, preferably 3.8 to 4.2 and in particular 4.0.

Particular preference is given to mixtures containing at least two organosilyl polysulfides of formula (Ia) and/or formula (Ib), which differ in terms of the value x, wherein the number-average x of the number x of sulfur atoms is 3.6 to 4.4, preferably 3.8 to 4.2 and in particular 4.0.

The organosilyl polysulfides of formula (I) according to the invention may be produced by reacting at least two haloalkylsilyl ethers of formula (II)

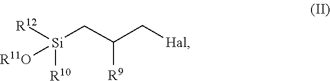

wherein
R⁹ represents a radical R⁴ or R⁵,
R¹⁰ represents a radical R³ or R⁶,
R¹¹ represents a radical R² or R⁷ and
R¹² represents a radical R¹ or R⁸,
wherein the radicals R¹ to R⁸ have the general and preferred definitions specified for formula (I) and
Hal represents halogen, preferably chlorine,
with at least one metal polysulfide of formula (III)

SₓM₂ (III),
wherein
x has the general and preferred definition specified for formula (I)
and
M represents a metal ion from the group of lithium, sodium and potassium, preferably sodium, in the presence of at least one alcoholic solvent.

Processes for producing organosilyl polysulfides are known in principle. The organosilyl polysulfides of formula (I) according to the invention may be produced by analogy with the known processes (as described for example in DE-A 2 141 159).

Producing the organosilyl polysulfides according to the invention generally comprises employing 0.5 mol of metal polysulfide of formula (III), particularly preferably sodium polysulfide, based on one mol of the total amount of haloalkylsilyl ethers of formula (II).

The process for producing the organosilyl polysulfides according to the invention may be performed over a wide temperature range. It is preferably performed at a temperature in the range from −20° C. to +90° C.

The process for producing the organosilyl polysulfides according to the invention is preferably performed in the presence of at least one alcohol from the group of methanol, ethanol, n-propanol, i-propanol, i-butanol, amyl alcohol, hexyl alcohol, n-octanol, i-octanol, ethylene glycol, 1.2- and 1,3-propylene glycol, 1,4-butanediol and/or 1,6-hexanediol.

The process for producing the organosilyl polysulfides according to the invention may be performed over a wide pressure range. It is generally performed at a pressure of 0.9 to 1.1 bar, preferably at standard pressure.

Production of the organosilyl polysulfides (I) according to the invention is generally carried out by initially charging the metal polysulfide of formula (III) in an anhydrous alcohol, preferably in anhydrous methanol, and heating the mixture to boiling point under inert conditions and then adding at least two haloalkylsilyl ethers of formula (II). Upon completion of the reaction the precipitated alkali metal salt is filtered off as a byproduct and the compounds of formula (I) are freed of solvent by distillation and isolated in pure form as the remaining bottoms product in a yield of >85%.

The haloalkysilyl ethers of formula (II) are novel and likewise form part of the subject matter of the present invention.

Processes for producing haloalkysilyl ethers are known in principle.

The haloalkysilyl ethers of formula (II) according to the invention are producible in known fashion, for example analogously to the process described in EP-A 0669338, by reacting at least one haloallyl compound of formula (IV)

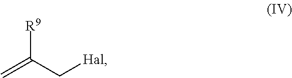

wherein R⁹ has the general and preferred definition specified for formula (II)
and
Hal represents halogen, preferably chlorine,
with at least one silane of formula (V)

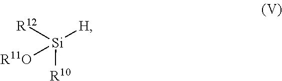

wherein R¹⁰, R¹¹ and R¹² have the general and preferred definitions specified for formula (II),
in the presence of at least one ruthenium catalyst.

Production of the haloalkysilyl ethers of formula (II) according to the invention is preferably carried out without addition of a solvent.

Generally 1.15 to 2.0 mol, preferably 1.6 to 2.0 mol, of silane of formula (V) are employed per mol of haloallyl compound of formula (IV).

Suitable ruthenium catalysts preferably include the compounds disclosed in EP-A 0669338. The ruthenium catalyst Ru₃(CO)₁₂ is especially suitable for producing the haloalkysilyl ether of formula (II) according to the invention.

Generally 10 to 200 ppm, preferably 15 to 100 ppm, of at least one ruthenium catalyst are employed per mol of haloallyl compound of formula (IV).

The reaction of the haloallyl compounds of formula (IV) with the silanes of formula (V) is generally carried out at a temperature in the range from 20° C. to 150° C., preferably from 70° C. to 90° C.

The reaction is generally carried out over a period of 1 to 100 hours, preferably over a period of 1.5 to 5 hours.

The progress of the reaction may be monitored by TLC (thin layer chromatography). Once reaction is complete the haloalkylsilyl ether of formula (II) may be purified by distillation. This makes it possible to realize yields of up to 97%.

The haloallyl compounds of formula (IV) are known and are obtainable for example as commercial products from Sigma-Aldrich (CAS No.: 107-05-1 or CAS No.: 563-47-3).

The silanes of formula (V) are producible in a known manner by reacting halosilanes of formula (VI)

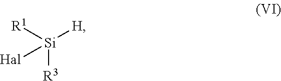

wherein
R¹ and R³ have the general and preferred definitions specified for formula (I)
and
Hal represents halogen, preferably chlorine,
with an alcohol of formula R¹¹OH, wherein R¹¹ has the general and preferred definitions specified for formula (I).

Silanes of formula (VI) are known and are obtainable as commercial products for example from Sigma-Aldrich.

The present invention further provides rubber mixtures containing at least one rubber and at least one compound of formula (I)

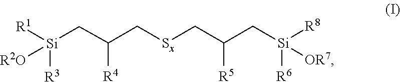

wherein the substituents R¹ to R⁸ and the index x have the general and preferred definitions specified above.

Generally the total content of compounds of formula (I) in the rubber mixtures according to the invention is 0.1 to 18 parts by weight, preferably 1 to 17 parts by weight, particularly preferably 2 to 16 parts by weight and very particularly preferably 3 to 15 parts by weight, in each case based on 100 parts by weight of the total amount of rubber.

The compounds of formula (I) may be added to the rubber mixtures in pure form or else absorbed on an inert organic or inorganic carrier. Suitable carrier materials are in particular silicas, natural or synthetic silicates, aluminium oxide and carbon blacks.

The rubber mixtures according to the invention comprise at least one rubber.

It is preferable when the rubber mixtures according to the invention contain at least one natural rubber (NR) and/or synthetic rubber.

Suitable synthetic rubbers include for example
BR—polybutadiene
ABR—butadiene/C₁-C₄-alkyl acrylate copolymer
CR—polychloroprene
IR—polyisoprene
SBR—styrene/butadiene copolymers having styrene contents of 1-60%, preferably 20-50%, by weight
IIR—isobutylene/isoprene copolymers
NBR—butadiene/acrylonitrile copolymers with acrylonitrile contents of 5% to 60% by weight, preferably 10-50% by weight,
HNBR—partially or fully hydrogenated NBR rubber
EPDM—ethylene/propylene/diene copolymers
and mixtures of two or more of these rubbers.

It is preferable when the rubber mixtures according to the invention contain at least one SBR rubber, preferably a functionalized SBR rubber, and optionally one or more BR rubbers.

According to the invention functionalized SBR rubber is an SBR rubber which is substituted at the main chain and/or at the end groups by one or more functional groups, in particular carboxyl groups and/or mercaptan-containing groups.

The rubber mixtures according to the invention very particularly preferably contain mixtures of SBR and BR rubbers in the weight ratio SBR:BR of 100:0 to 60:40.

In a further advantageous embodiment the rubber mixtures according to the invention contain at least one natural rubber.

The rubber mixtures according to the invention preferably contain one or more fillers. Suitable fillers in principle include all fillers known for this purpose from the prior art.

Suitable active fillers in particular include hydroxyl-containing oxidic compounds such as specific silicas and also carbon blacks.

The rubber mixtures according to the invention generally contain 10 to 190 parts by weight, preferably 30 to 150 parts by weight and particularly preferably 50 to 130 parts by weight of at least one filler, in each case based on 100 parts by weight of the total amount of rubber.

The rubber mixtures according to the invention preferably contain at least one hydroxyl-containing oxidic filler.

Generally the content of hydroxyl-containing oxidic fillers in the rubber mixtures according to the invention is at least 10 parts by weight, preferably 20 to 150 parts by weight, particularly preferably 50 to 140 parts by weight and very particularly preferably 80 to 130 parts by weight, in each case based on 100 parts by weight of the total filler content. Suitable hydroxyl-containing oxidic fillers are preferably those from the group of
silicas having a specific surface area (BET) of 5 to 1000, preferably 20 to 400 m²/g, and having primary particle sizes of 100 to 400 nm, wherein the silicas are optionally also in the form of mixed oxides with other metal oxides, such as oxides of Al, Mg, Ca, Ba, Zn, Zr, Ti, and
synthetic silicates, such as aluminium silicate, alkaline earth metal silicates such as magnesium silicate or calcium silicate, having specific surface areas (BET) of 20 to 400 m²/g and primary particle diameters of 10 to 400 nm.

The hydroxyl-containing oxidic fillers that are present in the rubber mixtures of the invention and are from the group of the silicas are preferably those that can be produced, for example, by precipitation of solutions of silicates or flame hydrolysis of silicon halides.

It is preferable when the rubber mixtures according to the invention contain at least one hydroxyl-containing oxide filler selected from the group of silicas having a specific surface area (BET) in the range from 20 to 400 m²/g in an amount of 5 to 150 parts by weight, preferably 50 to 140 parts by weight and particularly preferably of 80 to 130 parts by weight, in each case based on 100 parts by weight of the total amount of rubber.

The rubber mixtures according to the invention may further comprise at least one carbon black as filler.

Preference according to the invention is given to carbon blacks that are obtainable by the lamp black, furnace black or gas black method and have a specific surface area (BET) in the range from 20 to 2002/g, for example SAF, ISAF, IISAF, HAF, FEF or GPF carbon blacks.

The rubber mixtures according to the invention generally contain at least one carbon black having a specific surface area (BET) in the range from 20 to 200 m²/g in an amount of 0 to 40 parts by weight, preferably of 0 to 30 parts by weight and particularly preferably of 0 to 20 parts by weight, in each case based on 100 parts by weight of the total amount of rubber.

All BET figures relate to the specific surface area measured to DIN 66131. The reported primary particle sizes relate to values determined by scanning electron microscope.

In a preferred alternative embodiment the rubber mixtures according to the invention contain at least one of the abovementioned carbon blacks and at least one of the abovementioned silicas as fillers.

In a particularly preferred alternative embodiment the rubber mixtures according to the invention contain at least one hydroxyl-containing oxidic filler from the group of silicas having a specific surface area (BET) in the range from 20 to 400 m²/g in an amount of 20 to 120 parts by weight, preferably 30 to 100 parts by weight and particularly preferably of 40 to 90 parts by weight, and at least one carbon black having a specific surface area (BET) in the range from 20 to 200 m²/g in an amount of 20 to 90 parts by weight, preferably of 30 to 80 parts by weight and particularly preferably of 40 to 70 parts by weight, in each case based on 100 parts by weight of the total amount of rubber.

The rubber mixtures of the invention may comprise one or more crosslinkers.

Crosslinkers preferred according to the invention are in particular sulfur and sulfur donors and also metal oxides such as magnesium oxide and/or zinc oxide.

Sulfur may be employed in elemental soluble or insoluble form or in the form of sulfur donors. Suitable sulfur donors include for example dithiodimorpholine (DTDM), 2-morpholinodithiobenzothiazole (MBSS), caprolactam disulfide, dipentamethylenethiuram tetrasulfide (DPTT) and tetramethylthiuram disulfide (TMTD).

It is particularly preferable when the rubber mixtures according to the invention contain at least one sulfur donor and/or sulfur, especially sulfur.

The rubber mixtures according to the invention generally contain 0.1 to 10 parts by weight, preferably 0.2 to 5 parts by weight of at least one of the recited crosslinkers, in each case based on 100 parts by weight of the total amount of rubber.

The rubber mixtures according to the invention may contain one or more vulcanization accelerators.

Preferred vulcanization accelerators according to the invention are mercaptobenzothiazoles, mercaptosulfenamides, thiocarbamates, thiocarbonates and dithiophosphates as well as sulfur donors such as dithiodicaprolactams, dithiodimorpholines and xanthates.

The rubber mixtures according to the invention generally contain 0.1 to 10 parts by weight, preferably 0.2 to 5 parts by weight, of at least one of the recited vulcanization accelerators, in each case based on 100 parts by weight of the total amount of rubber.

In addition to the compounds of formula (I) the rubber mixtures according to the invention may also contain one or more further reinforcing additives customary for these purposes and known from the prior art.

In addition to the abovementioned additives the rubber mixtures according to the invention may also contain further rubber auxiliaries familiar to those skilled in the art, such as reaction accelerators, ageing stabilizers, heat stabilizers, light stabilizers, antiozonants, processing aids, plasticizers, tackifiers, blowing agents, dyes, pigments, waxes, extenders, organic acids, reaction retarders, metal oxides, activators such as triethanolamine, polyethylene glycol, hexanetriol and fillers from the group of natural silicates, such as kaolin and other naturally occurring silicas and moreover glass fibres and glass fibre products, for example in the form of mats, strands or microspheres.

The rubber mixtures according to the invention contain the recited rubber auxiliaries in the amounts customary for these auxiliaries, typically in each case in an amount of 0.1 to 30 parts by weight, in each case based on 100 parts by weight of the total amount of rubber.

The rubber mixtures according to the invention may contain one or more secondary accelerators.

In silica-based rubber mixtures as used for tyre production, diphenylguanidine (DPG) or structurally similar aromatic guanidines are typically used as secondary accelerators for controlled adjustment of the crosslinking rate and the mixture viscosity within the mixing process. However, a very important adverse feature associated with the use of DPG is that it releases aniline during vulcanization, which is suspected to be carcinogenic. It is now been found that, surprisingly, in the rubber mixtures of the invention, DPG can advantageously be replaced by 1,6-bis(N,N-dibenzylthiocarbamoyldithio)hexane (trade name: Vulcuren®). Replacement of DPG by secondary accelerators such as TBzTD (tetrabenzylthiuram disulfide) or dithiophosphates is also possible.

The present invention therefore also encompasses essentially DPG-free rubber mixtures.

The silica-based rubber mixtures according to the invention preferably contain at least one secondary accelerator from the group of 1,6-bis(N,N-dibenzylthiocarbamoyldithio)hexane (trade name: Vulcuren®), tetrabenzylthiuram disulfide (TBzTD) and dithiophosphates.

The rubber mixtures according to the invention generally contain 0.1 to 1.0 parts by weight, preferably 0.2 to 0.5 parts by weight of at least one of the recited secondary accelerators, in each case based on 100 parts by weight of the total quantity of rubber.

The present invention therefore also provides rubber mixtures of the invention that are essentially free of diphenylguanidine and/or substituted diphenylguanidines especially those having a content of diphenylguanidine and/or substituted diphenylguanidines of at most 0.4 parts by weight, preferably of 0.1 to 0.2 parts by weight, particularly preferably of 0.05 to 0.1 parts by weight and very particularly preferably of 0.001 to 0.04 parts by weight, in each case based on 100 parts by weight of the total amount of rubber.

Preference is given to rubber mixtures according to the invention containing at least one rubber, 5 to 150 parts by weight, preferably 50 to 140 parts by weight and particularly preferably 80 to 130 parts by weight of at least one silica, 0 to 40 parts by weight, preferably 0 to 30 parts by weight and particularly preferably 0 to 20 parts by weight of carbon black and 0.1 to 15, preferably 1 to 12, particularly preferably 2 to 10, parts by weight and in particular 3 to 8 parts by weight of at least one compound of formula (I), in each case based on 100 parts by weight of the total amount of rubber.

Preference is likewise given to rubber mixtures according to the invention containing at least one rubber, 5 to 150 parts by weight, preferably 50 to 140 parts by weight and particularly preferably 80 to 130 parts by weight of at least one silica, 0 to 40 parts by weight, preferably 0 to 30 parts by weight and particularly preferably 0 to 20 parts by weight of carbon black and 0.1 to 18, preferably 1 to 17, particularly preferably 2 to 16, parts by weight and in particular 3 to 15 parts by weight of at least one compound of formula (I) and 0.1 to 1.0 parts by weight of 1,6-bis(N,N-dibenzylthiocarbamoyldithio)hexane (Vulcuren®), in each case based on 100 parts by weight of the total amount of rubber.

Very particular preference is given to rubber mixtures according to the invention containing at least one rubber, in particular at least one SBR rubber, preferably a functionalized SBR rubber and optionally one or more BR rubbers, 5 to 150 parts by weight, preferably 50 to 140 parts by weight and particularly preferably 80 to 130 parts by weight of at least one silica, in particular having a specific surface area (BET) of 5 to 1000 m²/g, preferably 20 to 400 m²/g, and having primary particle sizes of 100 to 400 nm, 0 to 40 parts by weight, preferably 0 to 30 parts by weight and particularly preferably 0 to 20 parts by weight of carbon black, in particular having a specific surface area (BET) in the range from 20 to 200 m²/g, and 0.1 to 15, preferably 1 to 14, particularly preferably 2 to 13, parts by weight and in particular 3 to 11 parts by weight of at least one compound of formula (I), in particular of formula (Ia) (bis[penta(ethyleneoxy)tridecanoyldimethylsilylpropyl]polysulfide), and/or of formula (Ib) (bis[penta(ethyleneoxy)tridecanoyldimethylsilylisobutyl]polysulfide), in each case based on 100 parts by weight of the total amount of rubber.

Very particular preference is also given to rubber mixtures according to the invention containing at least one rubber, in particular at least one SBR rubber, preferably a functionalized SBR rubber and optionally one or more BR rubbers, 5 to 150 parts by weight, preferably 50 to 140 parts by weight and particularly preferably 80 to 130 parts by weight of at least one silica, in particular having a specific surface area (BET) of 5 to 1000 m²/g, preferably 20 to 400 m²/g, and having primary particle sizes of 100 to 400 nm, 0 to 40 parts by weight, preferably 0 to 30 parts by weight and particularly preferably 0 to 20 parts by weight of carbon black, in particular having a specific surface area (BET) in the range from 20 to 200 m²/g, and 0.1 to 18, preferably 1 to 17, particularly preferably 2 to 16, parts by weight and in particular 3 to 15 parts by weight of at least one compound of formula (I), in particular of formula (Ia) (bis[penta(ethyleneoxy)tridecanoyldimethylsilylpropyl]polysulfide) and/or of formula (Ib) (bis[penta(ethyleneoxy)tridecanoyldimethylsilylisobutyl]polysulfide) and 0.1 to 0.5 parts by weight of 1,6-bis(N,N-dibenzylthiocarbamoyldithio)hexane (Vulcuren®) and a content of diphenylguanidine and/or substituted diphenylguanidines of at most 0.4 parts by weight, preferably of 0.1 to 0.2 parts by weight, particularly preferably of 0.05 to 0.1 parts by weight and very particularly preferably of 0.001 to 0.04 parts by weight, in each case based on 100 parts by weight of the total amount of rubber.

Very particular preference is likewise given to rubber mixtures according to the invention containing at least one natural rubber, 5 to 150 parts by weight, preferably 50 to 140 parts by weight and particularly preferably 80 to 130 parts by weight of at least one silica, in particular having a specific surface area (BET) of 5 to 1000 m²/g, preferably 20 to 400 m²/g, and having primary particle sizes of 100 to 400 nm, 0 to 40 parts by weight, preferably 0 to 30 parts by weight and particularly preferably 0 to 20 parts by weight of carbon black, in particular having a specific surface area (BET) in the range from 20 to 200 m²/g, and 0.1 to 18, preferably 1 to 17, particularly preferably 2 to 16, parts by weight and in particular 3 to 15 parts by weight of at least one compound of formula (I), in particular of formula (Ia) (bis[penta(ethyleneoxy)tridecanoyldimethylsilylpropyl]polysulfide) and/or of formula (Ib) (bis[penta(ethyleneoxy)tridecanoyldimethylsilylisobutyl]polysulfide), in each case based on 100 parts by weight of the total amount of rubber.

Very particular preference is also given to rubber mixtures according to the invention containing at least one natural rubber, 5 to 150 parts by weight, preferably 50 to 140 parts by weight and particularly preferably 80 to 130 parts by weight of at least one silica, in particular having a specific surface area (BET) of 5 to 1000 m²/g, preferably 20 to 400 m²/g, and having primary particle sizes of 100 to 400 nm, 0 to 40 parts by weight, preferably 0 to 30 parts by weight and particularly preferably 0 to 20 parts by weight of carbon black, in particular having a specific surface area (BET) in the range from 20 to 200 m²/g, and 0.1 to 18, preferably 1 to 17, particularly preferably 2 to 16, parts by weight and in particular 3 to 15 parts by weight of at least one compound of formula (I), in particular of formula (Ia) (bis[penta(ethyleneoxy)tridecanoyldimethylsilylpropyl]polysulfide) and/or of formula (Ib) (bis[penta(ethyleneoxy)tridecanoyldimethylsilylisobutyl]polysulfide) and 0.1 to 0.5 parts by weight of 1,6-bis(N, N-dibenzylthiocarbamoyldithio)hexane (Vulcuren®) and a content of diphenylguanidine and/or substituted diphenylguanidines of at most 0.4 parts by weight, preferably of 0.1 to 0.2 parts by weight, particularly preferably of 0.05 to 0.1 parts by weight and very particularly preferably of 0.001 to 0.04 parts by weight, in each case based on 100 parts by weight of the total amount of rubber.

The present invention further provides a process for producing the rubber mixtures according to the invention by mixing at least one of the rubbers generally recited or recited as preferred above with at least one of the fillers generally recited or recited as preferred above and at least one compound of formula (I) and optionally with at least one of the reinforcing additives generally recited or recited as preferred above, optionally one or more of the vulcanization accelerators generally recited or recited as preferred above and optionally one or more of the secondary accelerators generally recited or recited as preferred above and optionally one or more of the abovementioned rubber auxiliaries in the general and preferred amounts specified for these additives and heating the resulting mixture to a temperature in the range from 60° C. to 200° C., particularly preferably from 90° C. to 180° C.

Production of the rubber mixtures according to the invention typically employs, per 100 parts by weight of the total amount of rubber, 10 to 190 parts by weight, preferably 30 to 150 parts by weight and particularly preferably 50 to 130 parts by weight of at least one filler and 0.1 to 15 parts by weight, preferably 1 to 12 parts by weight, particularly preferably 2 to 10 parts by weight and very particularly preferably 3 to 8 parts by weight of at least one compound of formula (I) and optionally one or more of the abovementioned additives in the amounts specified for these additives.

The rubber mixtures according to the invention may alternatively be produced by mixing at least one compound of formula (I) where x=2 at a temperature of 100° C. to 200° C., preferably 130° C. to 180° C., with sulfur and at least one rubber and at least one filler. In this alternative process the incorporation of further sulfur atoms into the compound of formula (I) where x=2 is effected in situ, thus forming the compounds of formula (I) according to the invention where x=2 to 8 and the number-average of x=4.

Production of the rubber mixtures according to the invention is carried out in customary fashion in known mixing apparatuses, such as rollers, internal mixers and mixing extruders at melt temperatures of 60° C. to 200° C., preferably 100° C. to 200° C., and at shear rates of 1 to 1000 sec-1.

The addition of the compounds of formula (I) and the addition of the fillers is preferably carried out in the first part of the mixing operation at melt temperatures of 60° C. to 200° C., preferably 100° C. to 200° C., and the recited shear rates. However, said addition may also be carried out in later parts of the mixing operation at lower temperatures (40° C. to 130° C., preferably 40° C. to 100° C.), for example together with sulfur and vulcanization accelerators.

The present invention further provides a process for the vulcanization of the rubber mixtures of the invention which is preferably carried out at melt temperatures of 100° C. to 200° C., particularly preferably at 130° C. to 180° C. In a preferred embodiment vulcanization is carried out at a pressure of 10 to 200 bar.

The present invention also comprises rubber vulcanizates obtainable by vulcanization of the rubber mixtures of the invention. These vulcanizates, especially when used in tyres, have the benefits of an excellent profile of properties and unexpectedly low rolling resistance.

The rubber vulcanizates according to the invention are suitable for producing moulded articles having improved properties, for example for producing cable sheathings, hoses, drive belts, conveyor belts, roller coverings, tyres, shoe soles, sealing rings and damping elements, particularly preferably for producing tyres.

The present invention further provides for the use of the compounds of formula (I) for producing rubber mixtures and vulcanizates thereof.

### EXAMPLES

The invention is to be elucidated by the examples that follow, but without being limited thereto.

### Determination of Properties of Rubber Mixture/Vulcanizates:

### Rheometer (Vulcameter) Complete Vulcanization Time 170° C./t95:

The MDR (moving die rheometer) vulcanization profile and analytical data associated therewith are measured in an MDR 2000 Monsanto rheometer in accordance with ASTM D5289-95. The time at which 95% of the rubber has been crosslinked is determined as the complete vulcanization time. The temperature chosen was 170° C.

### Determination of Hardness:

To determine the hardness of the rubber mixture according to the invention rolled sheets of 6 mm in thickness were produced from the rubber mixture according to formulations in table 1. Test specimens of 35 mm diameter were cut from the rolled sheets whose Shore A hardness was determined by means of a digital Shore hardness tester (Zwick GmbH & Co. KG, Ulm). The hardness of a rubber vulcanizate gives a first indication of its stiffness.

### Tensile Test:

The tensile test is used directly to determine the load limits of an elastomer and is carried out according to DIN 53504. The longitudinal elongation at break is divided by the initial length to give the breaking elongation. Furthermore the force for achieving certain elongation levels, usually 50%, 100%, 200% and 300%, is also determined and expressed as a stress value (tensile strength at the specified elongation of 300% or 300 modulus).

Dyn. Damping:

Dynamic test methods are used to characterize the deformation behaviour of elastomers under periodically changing loads. An externally applied voltage alters the conformation of the polymer chain. The loss factor tan δ is determined indirectly by way of the ratio of the loss modulus G″ to the storage modulus G′. The loss factor tan δ at 60° C. is associated with rolling resistance and should be as low as possible. The loss factor tan δ at 0° C. is associated with wet grip and should be as high as possible.

### List of Feedstocks, Abbreviations and Manufacturers

| Name/ | | Manufacturer/ |
|---|---|---|
| trade name | Description | distributor |
| BUNA ® VSL 4526-2 HM | SBR rubber | ARLANXEO |
| | | Deutschland |
| | | GmbH |
| BUNA ® CB 24 | BR rubber | ARLANXEO |
| | | Deutschland |
| | | GmbH |
| VULKASIL ® S | Silica, spec. surface area 175 m²/g | LANXESS |
| | | Deutschland |
| | | GmbH |
| ROTSIEGEL zinc white | Zinc oxide | Grillo Zinkoxid |
| | | GmbH |
| CORAX ® N 339 | Carbon black, spec. surface area 90 m²/g | Evonik Industries |
| | | AG |
| TUDALEN ® 1849-2 | Mineral oil | Hansen&Rosenthal |
| | | KG |
| VULKANOX ® 4020/LG | N-1,3-dimethylbutyl-N-phenyl- | LANXESS |
| | p-phenylenediamine | Deutschland |
| | | GmbH |
| VULKANOX ® HS/LG | Oligomerized 2,2,4-trimethyl-1,2- | LANXESS |
| | dihydroquinoline | Deutschland |
| | | GmbH |
| ANTILUX ® 654 | Light protection wax | LANXESS |
| | | Deutschland |
| | | GmbH |
| TESPT (SI 69) | Bis(triethoxysilylpropyl)tetrasulfide | Evonik Industries |
| | | AG |
| DM-C13-EO-SiPT | Bis[penta(ethyleneoxy)-tridecanoyl- | inventive |
| Formel (Ia) | dimethylsilylpropyl]polysulfide | |
| DM-C13-EO-SiBT | Bis[penta(ethyleneoxy)-tridecanoyl- | inventive |
| Formel (Ib) | dimethylsilylisobutylpropyl]polysulfid | |
| RHENOGRAN ® DPG-80 | 1,3-diphenylguanidine | LANXESS |
| | | Deutschland |
| | | GmbH |
| VULKACIT ® CZ/C | N-cyclohexyl-2-benzothiazole | LANXESS |
| | sulfenamide | Deutschland |
| | | GmbH |
| PALMERA ® A9818 | Stearic acid | |
| VULCUREN ® | 1,6-bis(N,N-dibenzylthiocarbamoyldithio)- | LANXESS |
| | hexane | Deutschland |
| | | GmbH |

### Production of Organosilyl Polysulfides

### Example 1a: Production of bis[penta(ethyleneoxy)tridecanoyldimethylsilylpropyl]polysulfide

28.54 g (0.5 mol) of sodium polysulfide were initially charged in anhydrous methanol and heated to boiling under inert conditions. Then 555.31 g (1.0 mol) of penta(ethyleneoxy)tridecanoyldimethylsilylpropyl chloride was added and the reaction mixture was heated under reflux for 1.5 hours.

Once reaction was complete, the precipitated sodium chloride was filtered off and the solvent methanol removed by distillation under vacuum. The distillation residue contained the bis[penta(ethyleneoxy)tridecanoyldimethylsilylpropyl]polysulfide.

Yield: 83% of theory

### Example 1b: Production of bis[penta(ethyleneoxy)tridecanoyldimethylsilylisobutyl]polysulfide

The production of bis[penta(ethyleneoxy)tridecanoyldimethylsilylisobutylpropyl]polysulfide was carried out analogously to example 1a with the exception that 1.0 mol (569.34 g) of penta(ethyleneoxy)tridecanoyldimethylsilylisobutyl chloride was employed instead of 1.0 mol of penta(ethyleneoxy)tridecanoyldimethylsilylpropyl chloride.

Yield: 81% of theory.

### Production of Starting Compounds

### Example 1c: Production of penta(ethyleneoxy)tridecanoyldimethylsilylpropyl chloride

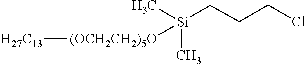

0.0249 g of the ruthenium catalyst Ru₃(CO)₁₂ (100 ppm Ru) and 282.49 g (0.590 mol) of penta(ethyleneoxy)tridecanoyldimethylsilane were initially charged in a reaction vessel. The reaction mixture was heated to 76° C. under reflux and 28.16 g (0.368 mol) of allyl chloride (Sigma-Aldrich (CAS No.: 107-05-1)) were added dropwise over a period of 30 minutes. The allyl chloride was determined to have undergone complete conversion by analysis by gas chromatography analysis after the reaction mixture had been heated at 80° C. for a further 90 minutes. The target compound was obtained in a yield of 94% of theory after distillative purification under high vacuum.

### Example 1d: Production of penta(ethyleneoxy)tridecanoyldimethylsilylisobutylpropyl chloride

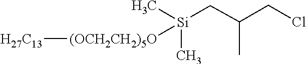

0.0249 g of the ruthenium catalyst Ru₃(CO)₁₂ (100 ppm Ru) and 282.49 g (0.590 mol) of penta(ethyleneoxy)tridecanoyldimethylsilane were initially charged in a reaction vessel. The reaction mixture was heated to 76° C. under reflux and 3.32 g (0.368 mol) of isobutene chloride (Sigma-Aldrich (CAS No.: 563-47-3)) were added dropwise over a period of 30 minutes. The allyl chloride was determined to have undergone complete conversion by analysis by gas chromatography analysis after the reaction mixture had been heated at 80° C. for a further 90 minutes. The target compound was obtained in a yield of 92% of theory after distillative purification under high vacuum.

### Example 1e: Production of penta(ethyleneoxy)tridecanoyldimethylsilane

94.62 g (1.0 mol) of chlorodimethylsilane (CAS No.: 1066-35-9) (Sigma-Aldrich) were initially charged in a reaction vessel and heated to 70° C. under reflux. Then 462.69 g (1.1 mol) of anhydrous Lutensol TO5 (BASF) were added over a period of 4.5 hours. The resulting HCl gas was passed via the cooler into an HCl trap (water+NaOH). The reaction mixture was then stirred for an additional hour at 80° C. under a nitrogen atmosphere.

In this way, the penta(ethyleneoxy)tridecanoyldimethylsilane was obtained in a yield of 96% of theory.

### Production of Rubber Mixtures

### Example 1

The inventive rubber mixtures A and B and the noninventive rubber mixture comparator 1 were produced according to the formulations reported in table 1. The compound bis(triethoxysilylpropyl)tetrasulfide (TESPT) and the compounds of formulae (Ia) and (Ib) were in each case employed in equimolar amounts. However, to achieve a comparable crosslinking density, a slightly higher sulfur amount was added in the case of the compounds of formulae (Ia) and (Ib). The mixtures were produced in a kneader at an internal temperature of 150° C. Sulfur and accelerator were subsequently mixed in on a roller at 50° C. To achieve vulcanization the mixtures were heated to 170° C. for 30 minutes in heatable presses.

Testing of the properties of the rubber mixtures and vulcanizates of mixtures A, B and comparator 1 was carried out according to the methods specified above.

It is apparent from the test data that the inventive rubber mixtures of examples A and B have a markedly lower mixing viscosity and thus result in a substantially more advantageous production of the vulcanizates than with the noninventive rubber mixture of comparator 1.

In addition to the improved producibility of the vulcanizates, the inventive rubber mixtures also show an improvement in the dynamic damping at 60° C. (measured as loss factor tan δ) which correlates with the rolling resistance of a tyre, where lower values are advantageous. It is additionally surprising that one of the great disadvantages of rubber mixtures comprising the additive TESPT, namely the so-called marching modulus of the crosslinking curve, does not occur in the case of the inventive rubber mixtures A and B. This entails simplified specification of the complete vulcanization time without constantly changing dynamic mechanical vulcanization properties. Further advantages in the production (vulcanization) of moulded articles may be derived from the shortened complete vulcanization time (t95) of the inventive rubber mixtures.

TABLE 1

| | Comp. 1 | A | B |
|---|---|---|---|
| Formulation | | | |
| BUNA ® VSL 4526-2 HM | 96 | 96 | 96 |
| BUNA ® CB 24 | 30 | 30 | 30 |
| VULKASIL ® S | 80 | 80 | 80 |
| Stearic acid | 1 | 1 | 1 |
| Zinc oxide | 2.5 | 2.5 | 2.5 |
| Carbon black CORAX ® N 339 | 6.4 | 6.4 | 6.4 |
| TUDALEN ® ® 1849-2 | 8 | 8 | 8 |
| VULKANOX ® ® HS/LG | 1 | 1 | 1 |
| VULKANOX ® ® 4020/LG | 1 | 1 | 1 |
| ANTILUX ® 654 | 1.5 | 1.5 | 1.5 |
| TESPT | 6.4 | — | — |
| DM-C13EO-SiBT | — | 14.2 | — |
| DM-C13EO-SiPT | — | — | 13.9 |
| On the roller/50 C.: | | | |
| VULKACIT ® CZ/C | 1.5 | 1.5 | 1.5 |
| RHENOGRAN ® DPG-80 | 2.5 | 2.5 | 2.5 |
| Sulfur | 1.5 | 2.1 | 2.1 |
| Complete vulcanization time T95 | 1157 | 517 | 344 |
| (s) | | | |
| Mooney viscosity, ML1 + 4 | 98 | 52 | 57 |
| (5th mixing stage) | | | |
| Mechanical properties: | | | |
| Strength (MPa) | 20.1 | 18.3 | 17.0 |
| Breaking elongation (%) | 356 | 524 | 425 |
| Elasticity (60° C.) | 55 | 58 | 59 |
| tan δ (0° C.) | 0.455 | 0.463 | 0.450 |
| tan δ (60° C.) | 0.117 | 0.114 | 0.104 |

### Example 2

The inventive rubber mixtures C and D and the noninventive rubber mixture comparator 1 were produced according to the formulations reported in table 2. The compound bis(triethoxysilylpropyl)tetrasulfide (TESPT) and the compounds of formulae (Ia) and (Ib) were in each case employed in equimolar amounts. However, to achieve a comparable crosslinking density, a slightly higher sulfur amount was added in the case of the compounds of formulae (Ia) and (Ib).

Furthermore, in the inventive rubber mixtures C and D the secondary accelerator DPG was in each case replaced by VULCUREN®.

The mixtures were produced in a kneader at an internal temperature of 150° C. Sulfur and accelerator were subsequently mixed in on a roller at 50° C. To achieve vulcanization the mixtures were heated to 170° C. for 30 minutes in heatable presses.

Testing of the properties of the rubber mixtures and vulcanizates of mixtures C, D and comparator 1 was carried out according to the methods specified above.

It is apparent from the test data that when using VULCUREN® as a DPG substitute in the inventive rubber mixtures C and D a lower mixture viscosity with improved scorch resistance (longer scorch time) relative to the noninventive rubber mixture of comparator 1 is achieved after the first mixing stage (5-stage mixing process). The complete vulcanization time T95 was significantly reduced relative to comparator 1.

The profile of mechanical properties of the inventive compounds such as the tensile strength remained largely unimpaired upon substitution of DPG by VULCUREN®. The rebound elasticity at 60° C. is markedly increased, accompanied by a smaller loss factor tan delta at 60° C. This improvement is an indicator of a lower rolling resistance.

TABLE 2

| | Comp. 1 | C | D |
|---|---|---|---|
| Formulation | | | |
| BUNA ® VSL 4526-2 HM | 96 | 96 | 96 |
| BUNA ® CB 24 | 30 | 30 | 30 |
| VULKASIL ® S | 80 | 80 | 80 |
| Stearic acid | 1 | 1 | 1 |
| Zinc oxide | 2.5 | 2.5 | 2.5 |
| Carbon black CORAX ® N 339 | 6.4 | 6.4 | 6.4 |
| TUALEN ® 1849-2 | 8 | 8 | 8 |
| VULKANOX ® HS/LG | 1 | 1 | 1 |
| VULKANOX ® 4020/LG | 1 | 1 | 1 |
| ANTILUX ® 654 | 1.5 | 1.5 | 1.5 |
| TESPT | 6.4 | — | — |
| DM-C13EO-SiBT | — | 14.2 | — |
| DM-C13EO-SiPT | — | — | 13.9 |
| On the roller/50 C.: | | | |
| VULKACIT ® CZ/C | 1.5 | 1.5 | 1.5 |
| RHENOGRAN ® DPG-80 | 2.5 | 0 | 0 |
| VULCUREN ® | 0 | 0.4 | 0.4 |
| Sulfur | 1.5 | 2.1 | 2.1 |
| Complete vulcanization time T95 | 1157 | 460 | 407 |
| (s) | | | |
| Mooney viscosity, ML1 + 4 | 140 | 106 | 99 |
| (1st mixing stage) | | | |
| Mooney scorch 130° C. (s) | 1279 | 1581 | 1170 |
| Mechanical properties: | | | |
| Strength (MPa) | 20.1 | 16.6 | 21.1 |
| Breaking elongation (%) | 356 | 512 | 513 |
| Elasticity (60° C.) | 54 | 55 | 60 |
| tan δ (0° C.) | 0.455 | 0.476 | 0.439 |
| tan δ (60° C.) | 0.117 | 0.113 | 0.098 |

### CONCLUSION

The inventive organosilyl polysulfides of formula (I) may be used to produce inventive rubber mixtures which feature improved mixing properties coupled with higher strength and markedly elevated elasticity (at 60° C.) of the vulcanizates produced therefrom. The tyres produced from the vulcanizates moreover feature a low rolling resistance.

1. Compounds of formula (I) 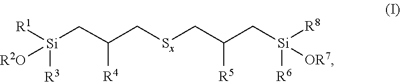
wherein
R¹, R³, R⁶ and R⁸ are identical or different and represent C₁-C₄-alkyl,
R⁴ and R⁵ are identical or different and represent hydrogen or C₁-C₄-alkyl,
R² and R⁷ represent a radical of formula (A),
H₂₇C₁₃—(OCH₂—CH₂)ₙ— (A)
wherein
n is an integer from 1 to 9,
and
x is an integer from 2 to 8.

2. The compounds according to claim 1, wherein in formula (I)
R¹, R³, R⁶ and R⁸ are identical or different and represent methyl or ethyl,
R⁴ and R⁵ are identical or different and represent hydrogen, methyl or ethyl,
R² and R⁷ represent a radical of formula (A), wherein
n is an integer from 2 to 8,
and
x is an integer from 2 to 8.

3. The compounds according to claim 1, wherein the compounds conform to formula 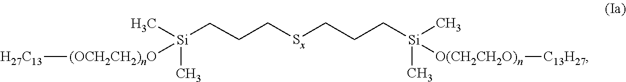
wherein
x is an integer from 2 to 8,
and
n is 5,
or formula 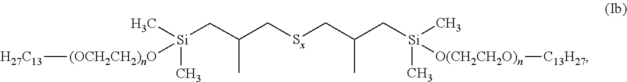
wherein
x is an integer from 2 to 8, and
n is 5.

4. Mixtures containing at least two organosilyl polysulfides of formula (I) according to claim 1, wherein the substituents R¹ to R⁸ and x have the definitions specified in claim 1 and which differ at least in the value of x, wherein the number-average x of the number x of sulfur atoms is 3.6 to 4.4.

5. Process for producing compounds according to claim 1, comprising reacting at least two haloalkylsilyl ethers of formula (II) 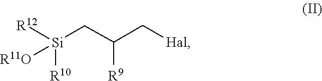
wherein
R⁹ represents a radical R⁴ or R⁵,
R¹⁰ represents a radical R³ or R⁶,
R¹¹ represents a radical R² or R⁷ and
R¹² represents a radical R¹ or R⁸,
wherein the radicals R¹ to R⁸ have the definitions specified in claim 1
and
Hal represents halogen,
with at least one metal polysulfide of formula (III)
SₓM₂ (III),
wherein
x has the definition specified in claim 1
and
M represents a metal ion from the group of lithium, sodium and potassium,
in the presence of at least one alcoholic solvent.

6. Haloalkylsilyl ether of formula (II) 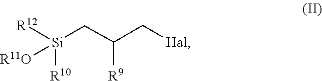
wherein
R⁹ represents a radical R⁴ or R⁵,
R¹⁰ represents a radical R³ or R⁶,
R¹¹ represents a radical R² or R⁷ and
R¹² represents a radical R¹ or R⁸,
wherein the radicals R¹ to R⁸ have the definitions specified in claim 1
and
Hal represents halogen.

7. A rubber mixture containing at least one rubber, at least one filler and at least one compound of formula (I) according to claim 1.

8. The rubber mixture according to claim 7, comprising altogether 0.1 to 18 parts by weight of compounds of formula (I) and 10 to 190 parts by weight of at least one filler, in each case based on 100 parts by weight of the total amount of rubber.

9. The rubber mixture according to claim 7, comprising at least one SBR rubber in the form of styrene/butadiene copolymers having styrene contents of 1% to 60% by weight a functionalized SBR rubber, one or more BR rubbers and/or at least one natural rubber (NR).

10. The rubber mixture according to claim 7, comprising at least one hydroxyl-containing oxidic filler from the group of silicas having a specific surface area (BET measured according to DIN 66131) of 5 to 1000 m²/g, and having primary particle sizes of 100 to 400 nm, wherein the silicas are optionally also in the form of mixed oxides with other metal oxides, such as oxides of Al, Mg, Ca, Ba, Zn, Zr, Ti, and synthetic silicates, such as aluminium silicate, alkaline earth metal silicates such as magnesium silicate or calcium silicate, having specific surface areas (BET measured according to DIN 66131) of 20 to 400 m²/g and primary particle diameters of 10 to 400 nm.

11. The rubber mixture according to claim 7, comprising at least one carbon black having a specific surface area (BET measured according to DIN 66131) in the range from 20 to 200 m²/g.

12. The rubber mixture according to any of claim 7, comprising at least one crosslinker from the group of sulfur and sulfur donors and metal oxides.

13. The rubber mixture according to any of claim 7, comprising at least one vulcanization accelerator from the group of mercaptobenzothiazoles, mercaptosulfenamides, thiocarbamates, thiocarbonates and dithiophosphates as well as sulfur donors such as dithiodicaprolactams, dithiodimorpholines and xanthates.

14. The rubber mixture according to any of claim 7, comprising at least one secondary accelerator from the group of 1,6-bis(N,N-dibenzylthiocarbamoyldithio)hexane, TBzTD (tetrabenzylthiuram disulfide) and dithiophosphate.

15. The Rubber mixture according to claim 7, wherein the rubber mixture has a content of diphenylguanidine and/or substituted diphenylguanidines of at most 0.4 parts by weight, based on 100 parts by weight of the total amount of rubber.

16. A process for producing a rubber mixture according to claim 7, comprising mixing at least one rubber with at least one filler and at least one compound of formula (I) according to claim 1 and heating the mixture to a temperature in the range from 60° C. to 200° C.

17. The process for producing a rubber mixture according to claim 7, further comprising mixing at least one rubber, at least one filler and at least one compound of formula (I), wherein x is 2, together with sulfur at a temperature in the range from 100° C. to 200° C.

18. The process for producing rubber vulcanizates by vulcanization of a rubber mixture according to claim 7 at a temperature in the range from 100° C. to 250° C.

19. Use of a rubber mixture according claim 7 for producing vulcanizates.

20. Vulcanizates obtainable by vulcanization of a rubber mixture according to claim 7.

21. Moulded articles, in particular tyres, containing one or more vulcanizates according to claim 20.

22. Use of compounds of formula (I) according to claim 1 for producing rubber mixtures according to claim 1.
